(19) United States
(12) Patent Application Publication
(10) Pub. No.: US 2016/0280186 A1
(43) Pub. Date: Sep. 29, 2016

(54) WIPER BLADE WITH IMPROVED WIPER STRIP

(71) Applicant: Pylon Manufacturing Corp., Deerfield Beach, FL (US)

(72) Inventors: Robert Peter Peers, Boca Raton, FL (US); Hiroshi Kawashima, Deerfield Beach, FL (US)

(21) Appl. No.: 15/082,619

(22) Filed: Mar. 28, 2016

Related U.S. Application Data
(60) Provisional application No. 62/139,383, filed on Mar. 27, 2015.

(51) Int. Cl. B60S 1/38

(52) U.S. Cl. CPC B60S 1/38

(57) ABSTRACT

A novel wiper strip is presented having a wiper lip made of a first material, a base strip, a neck connecting the wiper lip to the base strip, and a wiper lip insert made of a second material. The second material may be harder than the first material. Additionally, the wiper lip insert may further include a lip portion that is embedded in the wiper lip. A wiper blade having a mounting base, a force distribution structure and a wiper strip consistent with the description above is also presented.

### CROSS REFERENCE TO RELATED APPLICATIONS

This application claims the benefit of U.S. Provisional Application No. 62/139,383, filed Mar. 27, 2015, the disclosure of which is hereby incorporated herein by reference in its entirety.

### FIELD OF THE INVENTION

This invention relates to the field of windshield wiper blades.

### BACKGROUND

Typical wiper blades used on vehicles are plagued with numerous persistent drawbacks, including the use of wiper strips that do not have sufficient lateral strength to cleanly wipe water from a windshield without deforming during the wiping motion and leaving a streak of water on the windshield. Traditionally manufacturers have included strengthening vertebrae inserted into longitudinal grooves on the wiper strip to help provide lateral strength to the wiper strip. However, the problem still persists, particularly in the wiper lip, which is made of a relatively soft material.

### BRIEF SUMMARY OF THE INVENTION

The following presents a simplified summary of the invention in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

In one aspect, the disclosure provides a wiper strip having a wiper lip made of a first material; a base strip; a neck connecting the wiper lip to the base strip; and a wiper lip insert made of a second material. The second material may be harder than the first material. Further, the wiper lip insert may have a lip portion that is embedded in the wiper lip.

In another aspect, the disclosure provides a wiper blade having a mounting base, a force distribution structure, and a wiper strip. The wiper strip may have a wiper lip made of a first material, a base strip, a neck connecting the wiper lip to the base strip, and a wiper lip insert made of a second material. The second material may be harder than the first material, and the wiper lip insert may have a lip portion that is embedded in the wiper lip.

In yet another aspect, the disclosure provides a wiper strip having a wiper lip made of a first material, a base strip, an intermediate strip, a top strip, a main body connecting the base strip to the intermediate strip, an upper body connecting the top strip to the intermediate strip, a neck connecting the wiper lip to the base strip, a wiper lip insert made of a second material, and a body insert made of a third material. The base strip, main body and intermediary strip may form two claw grooves. Also, the top strip, upper body and intermediate strip may form two vertebra grooves. The second material is harder than the first material by a first amount in the range of Shore Hardness A 10-20 points. Further, the wiper lip insert may have a lip portion that is embedded in the wiper lip and a neck portion that extends from the lip portion and is embedded in the neck. The third material may be harder than the first material by a second amount in the range of Shore hardness A greater than 20 points, and the body insert may be embedded in the main body.

### BRIEF DESCRIPTION OF THE FIGURES

FIG. 1 illustrates a wiper strip profile of an embodiment of the disclosed concept.

FIG. 2 illustrates a wiper strip profile of an embodiment of the disclosed concept.

FIG. 3 illustrates a wiper strip profile of an embodiment of the disclosed concept.

FIG. 4 illustrates a wiper strip profile of an embodiment of the disclosed concept.

FIG. 5 illustrates a wiper strip profile of an embodiment of the disclosed concept.

FIG. 6 illustrates a wiper strip profile of an embodiment of the disclosed concept.

FIG. 7 illustrates a wiper strip profile of an embodiment of the disclosed concept.

FIG. 8 illustrates a wiper strip profile of an embodiment of the disclosed concept.

FIG. 9 illustrates a wiper blade embodiment of the disclosed concept.

### DETAILED DESCRIPTION

The following detailed description and the appended drawings describe and illustrate exemplary embodiments of the invention solely for the purpose of enabling one of ordinary skill in the relevant art to make and use the invention. As such, the detailed description and illustration of these embodiments are purely exemplary in nature and are in no way intended to limit the scope of the invention, or its protection, in any manner. It should also be understood that the drawings are not to scale and in certain instances details have been omitted, which are not necessary for an understanding of the present invention, such as conventional details of fabrication and assembly.

A novel design for wiper strip having differing hardness, and wiper blade incorporating same, are presented. Specifically, a wiper strip is presenting that is made primarily from a softer wiping material that has reinforcing portions made of a harder material embedded within.

In one aspect, the disclosure provides a wiper strip having a wiper lip made of a first material; a base strip; a neck connecting the wiper lip to the base strip; and a wiper lip insert made of a second material. The second material may be harder than the first material. Further, the wiper lip insert may have a lip portion that is embedded in the wiper lip.

In some embodiments, the wiper lip insert may further include a neck portion that extends from the lip portion and is embedded in the neck. Further, the wiper lip insert may also have a top portion connected to the neck portion, and that is embedded at least in part, in the base strip, where the neck portion has a first width, and the top portion has a second width, the second width being greater than the first width.

In some embodiments, the first material has a first hardness and the second material has a second hardness in the range of Shore Hardness A 10-20 points greater than that of the first material.

In further embodiments, the wiper strip may have a main body and a body insert that is embedded in the main body. The body insert may have an hour-glass shape.

In some embodiments, the wiper strip may further have a main body and an intermediate strip, where the base strip, main body and intermediate strip form claw grooves. The wiper strip may further have an upper body and top strip, where the top strip, upper body, and intermediate strip form vertebra grooves. The wiper strip may also have an upper body, a top strip, and a cap insert, where the top strip, upper body, and intermediate strip form two grooves, and where the cap insert has two cap legs, each having cap claws that engage the two grooves. The wiper strip may also have a claw groove insert and/or a vertebra groove insert.

In another aspect, the disclosure provides a wiper blade having a mounting base, a force distribution structure, and a wiper strip. The wiper strip may have a wiper lip made of a first material, a base strip, a neck connecting the wiper lip to the base strip, and a wiper lip insert made of a second material. The second material may be harder than the first material, and the wiper lip insert may have a lip portion that is embedded in the wiper lip.

In some embodiments, the wiper lip insert further includes a neck portion that extends from the lip portion and is embedded in the neck, and a top portion that is connected to the neck portion and is embedded at least in part, in the base strip, where the neck portion has a first width, and the top portion has a second width, the second width is greater than the first width.

In some embodiments, the first material has a first hardness and the second material has a second hardness in the range of Shore Hardness A 10-20 points greater than that of the first material.

In some embodiments, the wiper strip further has a main body, and a body insert that is embedded in the main body. The body insert may have an hour-glass shape.

In some embodiments, the wiper strip further has a main body and an intermediate strip, where the base strip, main body and intermediate strip form claw grooves. The wiper strip may further have an upper body and top strip, where the top strip, upper body, and intermediate strip form vertebra grooves.

In some embodiments, the wiper strip may further include an upper body, a top strip, and a cap insert, where the top strip, upper body, and intermediate strip form two grooves, and where the cap insert has two legs, each having claws that engage the two grooves.

In yet another aspect, the disclosure provides a wiper strip having a wiper lip made of a first material, a base strip, an intermediate strip, a top strip, a main body connecting the base strip to the intermediate strip, an upper body connecting the top strip to the intermediate strip, a neck connecting the wiper lip to the base strip, a wiper lip insert made of a second material, and a body insert made of a third material. The base strip, main body and intermediary strip may form two claw grooves. Also, the top strip, upper body and intermediate strip may form two vertebra grooves. The second material is harder than the first material by a first amount in the range of Shore Hardness A 10-20 points. Further, the wiper lip insert may have a lip portion that is embedded in the wiper lip and a neck portion that extends from the lip portion and is embedded in the neck. The third material may be harder than the first material by a second amount in the range of Shore hardness A greater than 20 points, and the body insert may be embedded in the main body.

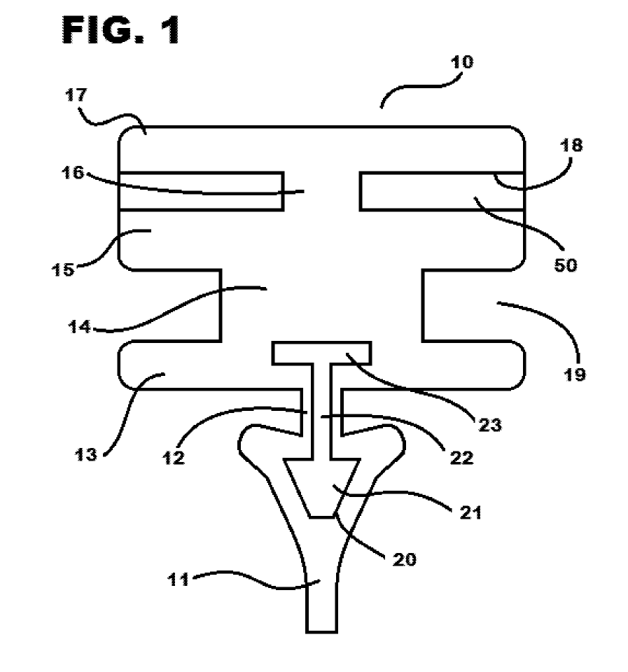

FIGS. 1 & 2 illustrate profiles of an elongate wiper strip 10 along its longitudinal axis. Wiper strip 10 has a wiper lip 11 which may have a substantially triangular shape, and is oriented downwards towards a window to be wiped when in use. Persons of skill in the art will recognize that other suitable wiper lip shapes may be practiced within the disclosed concept. The wiper lip 11 is connected to a base strip 13 via a neck 12. The neck 12 allows the wiper lip 11 to pivot as it is moved across a windshield to improve wipe quality. Base strip 13 may be connected to intermediate strip 15 via a main body 14. Longitudinal claw grooves 19 may be formed on the long sides of wiper strip 10 by the upper surface of base strip 13, the lower surface of intermediate strip 15, and the outer long sides of main body 14. The claw grooves 19 are preferably sized and shaped to slidably receive claws 61 from a wiper blade 1, and may be provided with locking structures, such as chamfers and/or detents either at one end of the wiper strip 10, or at various locations throughout the claw grooves 19, in order to secure the wiper strip in place. Persons of skill in the art will recognize that any of the securing structures known in the art, including without limitation, projections, recesses, stops, etc., may be utilized. Such structures may be disposed in the claw groove 19, on other parts of the wiper strip 10, on vertebrae 50 in the claws 61, or on other parts of the wiper blade 1 in order to keep the wiper strip 10 in place with respect to the claws 61. Intermediate strip 15 may be connected to top strip 17 via an upper body 16. Longitudinal vertebra grooves 18 may be formed on the long sides of wiper strip 10 by the upper surface of intermediate strip 15, the lower surface of top strip 17, and the outer long sides of upper body 16. The vertebra grooves 18 are preferably sized and shaped to receive a vertebra 50 which provide lateral support for the wiper strip 10. The vertebrae 50 may be preferably made of metal, whether rigid or spring elastic, but may alternatively be made of any suitable material known in the art, including without limitation plastic. As shown in FIG. 1, each vertebra 50 may be preferably sized to fit within and substantially or completely fill the vertebra grooves 18, but persons of skill in the art will recognize that the vertebrae may be sized wider, or narrower than the vertebra grooves 18. As shown in FIG. 1, top strip 17, upper body 16, intermediate strip 15, main body 14, base strip 13, are preferably generally rectangular in shape, and may have rounded or squared corners. However, persons of skill in the art will recognize that other suitable shapes, such providing these structures with angular surfaces, may be implemented if desired and remain within the scope of the disclosed concept. Similarly, the top strip 17, intermediate strip 15, and base strip 13 preferably have a substantially similar width, and are preferably wider than main body 14, which is in turn, preferably wider than the neck 12 and upper body 14. However, persons of ordinary skill in the art will recognize that the sizing and relative width between these structures will vary based on a particular implementation of the disclosed concept.

The top strip 17, upper body 16, intermediate strip 15, main body 14, base strip 13, are preferably made out of an elastic material, such as natural or synthetic rubber and preferably have a hardness that is soft enough to wipe water off of a windshield cleanly. These structures are preferably made from the same material, but may be made from different materials with different hardness in accordance with the disclosed concept. Typical wiper material hardness tends to have a Shore Hardness A in the range of approximately 58±5. However, the hardness may be adjusted up or down by up to 5, or up to 10, Shore Hardness A points, based on climate and other design considerations. Other suitable materials for these components include, but are not limited to, chloroprene, polyisoprene, butadiene isoprene, EDPM, NBR-PVC. Persons of skill in the art will recognize that the disclosed concept may be practiced with any suitable material, including those set forth below for the reinforcing wiper lip 20, the reinforcing groove inserts 31, 32 and the reinforcing body inserts 33, 34.

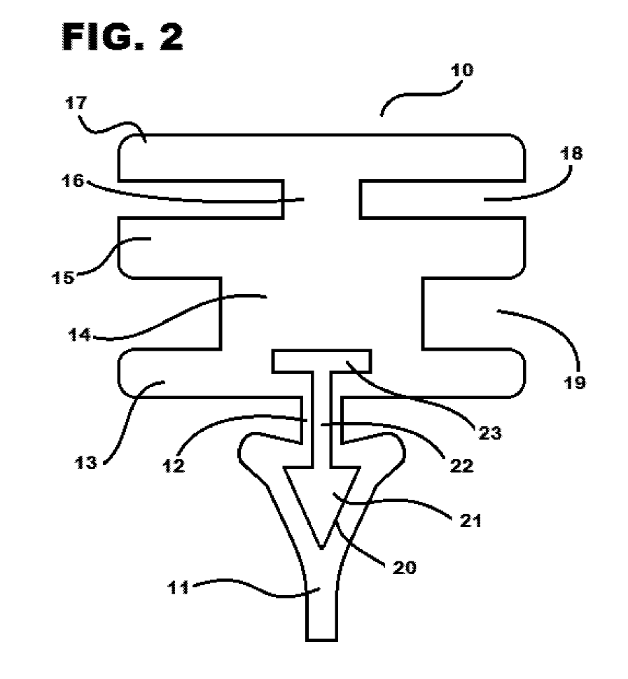

A reinforcing wiper lip insert 20 may be provided substantially, or entirely, within the wiper lip 11. The wiper lip insert may have a lip portion 21, which is embedded within, and surrounded by, the wiper lip 11. The lip portion 21 may have a shape that complementary to and may substantially match the shape of the wiper lip 11. For example, FIG. 1 shows a wiper lip insert 20 having a lip portion 21 that is trapezoidal in shape, but generally matches the triangular shape of the wiper lip 11. Similarly, FIG. 2 shows a wiper lip insert 20 having a lip portion 21 that is triangular in shape and generally matches the triangular shape of the wiper lip 11. The wiper lip insert section may also have a neck portion 22 that is embedded within, and surrounded by the neck 12 and extends from the lip portion into and/or through the neck 12 of the wiper strip 10. The wiper lip insert 20 may optionally have a top portion 23 that is embedded, at least in part, within either the base strip 13, or the main body 14, and is connected to the neck portion 22. The top portion 23 may have a width that is greater than the width of the neck portion 22, and may be rectangular in shape or have any other suitable shape. Persons of skill in the art will recognize that the lip portion 20, and more generally, the wiper lip insert 20 as a whole, may have suitable shape, including shapes that do not substantially match the shape of the wiper lip such as a simple rectangular shape matching and extending from the neck portion 22.

The wiper lip insert 20 may preferably run at least substantially along the entire length of the wiper lip 11. In some of these embodiments, the wiper lip insert 20 may run along the entire length of the wiper lip 11 such that the material composition of the wiper strip 10 keeps a constant profile along its entire length. In other embodiments, the wiper lip insert 20 may extend less than the entire length of the wiper lip 11. For example, the wiper lip insert 20 may stop short of the ends of the wiper lip 11, or the wiper lip insert 20 may comprise two or more sections interspersed throughout the wiper lip.

The wiper lip insert 20 is preferably made from a material that is harder than the material used for the wiper lip 11. More specifically, it may be advantageous to use a material having a Shore Hardness A of approximately 10 to 20 points greater than the hardness of the material of wiper lip 11. In some embodiments it may be advantageous to use a material with Shore Hardness A in the range of approximately 70±5. However, persons of skill in the art will recognize that certain implementations of the disclosed concept may use a material for the wiper lip insert 20 having a Shore Hardness A of less than 10, or more than 20, points greater than the hardness of the material of the wiper lip 11. Suitable materials include, but are not limited to, high or low density polyethylene (HDPE/LDPE), Nylon, polybutylene terephthalate (PBT), polyethylene terephthalate (PET), polypropylene (PP), polyphenylene sulfide (PPS), or silicone, as well as the same materials used for the wiper lip 11.

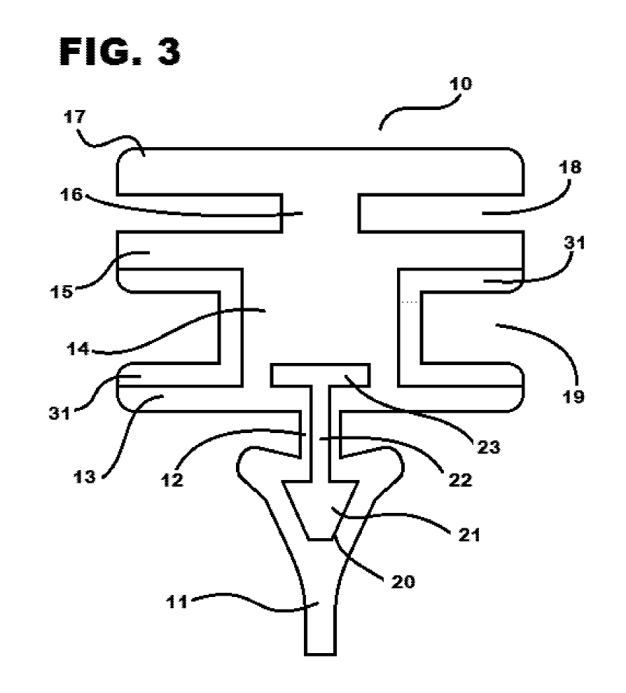

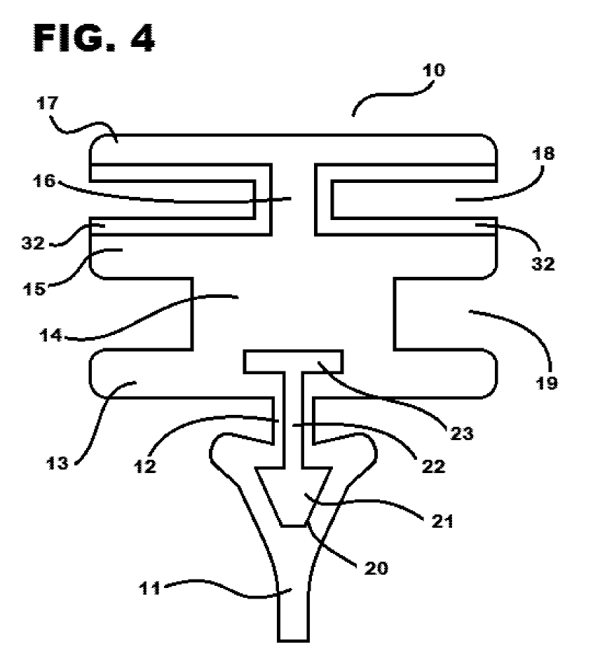

As shown in FIGS. 3 and 4, reinforcing groove inserts 31, 32 may be disposed along the edges of the longitudinal grooves 18, 19 in the wiper strip 10. FIG. 3 illustrates an embodiment of the disclosed concept in which a reinforcing claw groove insert 31 is formed along the upper surface of the base strip 13, the lower surface of the intermediate strip 15, and the long sides of the main body 14. The claw groove 19 is therefore formed within the claw groove insert 31, but otherwise has the same functionality and features. Likewise, FIG. 4 illustrates an embodiment of the disclosed concept in which a reinforcing vertebra groove insert 32 is formed along the upper surface of the intermediate strip 15, the lower surface of the top strip 17, and the long sides of the upper body 16. The vertebra groove 18 is therefore formed within the claw groove insert 32, but otherwise has the same functionality and features.

The groove inserts 31,32 are preferably made from a material that is harder than the material used for the wiper lip 11. More specifically, it may be advantageous to use a material having a Shore Hardness A of more than 20 points greater than the hardness of the material of wiper lip 11. In some embodiments, it may be advantageous to use a material with Shore Hardness A in the range of approximately 85±5. However, persons of skill in the art will recognize that certain implementations of the disclosed concept may use a material for the groove inserts 31, 32 having a Shore Hardness A of less than 20 points greater than the hardness of the material of the wiper lip 11. Suitable materials include, but are not limited to, high or low density polyethylene (HDPE/LDPE), Nylon, polybutylene terephthalate (PBT), polyethylene terephthalate (PET), polypropylene (PP), polyphenylene sulfide (PPS), or silicone, as well as the same materials used for the wiper lip 11.

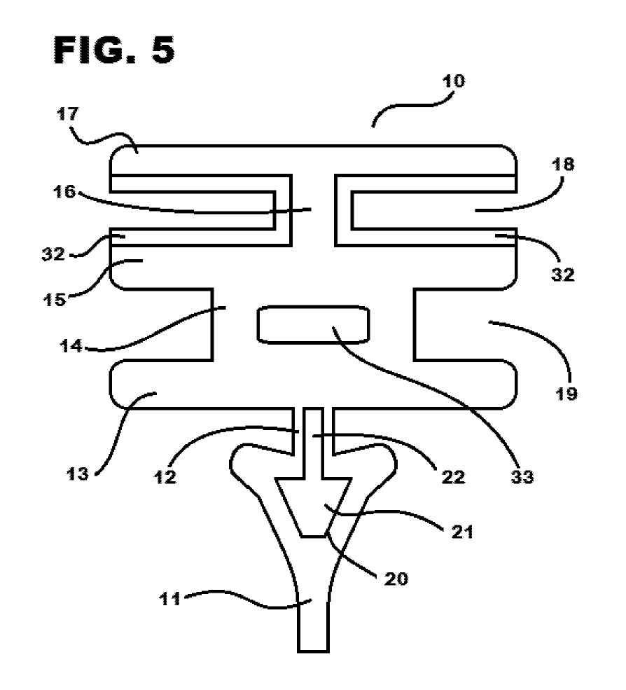

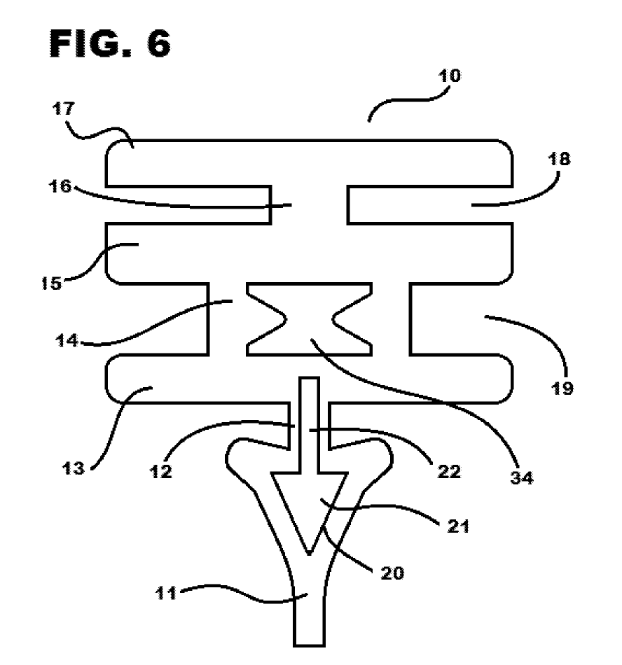

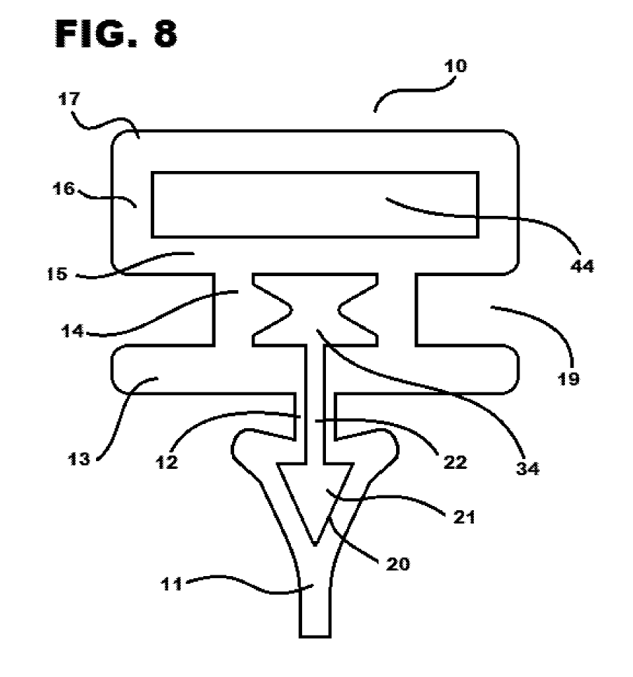

As shown in FIGS. 5, 6, 7 and 8, reinforcing body inserts 33, 34, 44 may be embedded within, and surrounded by the main body 14 or upper body 16 of the wiper strip 10 to provide additional support and strength to the wiper blade 10. FIG. 5 illustrates an embodiment of the disclosed concept in which a rectangular main body insert 33 is formed within the main body 14 of the wiper strip 10. FIGS. 6-8 further illustrate embodiments of the disclosed concept in which an hour-glass shaped main body insert 34 is formed within the main body 14. Likewise, FIG. 8 also illustrates an embodiment of the disclosed concept in which a reinforcing upper body insert 44 is formed within and between the top strip 17, intermediate strip 15, and the upper body 16. Persons of skill in the art will recognize that the shapes shown in FIGS. 5-9 are exemplary and that any suitable shape may be provided for the reinforcing body inserts 33, 34, 44. As shown in FIG. 8, an upper body insert may be used in lieu of vertebrae 50, making the vertebra grooves 18 unnecessary.

As also shown in FIG. 8, where multiple inserts are used, the inserts may be joined together, whether made from the same material or not. Specifically, FIG. 8 illustrates an embodiment where the lip insert 20, melds with the hour-glass shaped main body insert 34. Similarly, main body inserts 33, 34 can be joined to upper body inserts 44, or groove inserts 31, 32. Alternatively, FIGS. 5-7 illustrate alternate embodiments of the wiper lip insert 20 that do not have a top portion 23. As illustrated in FIG. 5, the neck portion 22 of the wiper lip insert 20 may extend through the neck, but not enter the base strip 13. As illustrated in FIGS. 6 & 7, the neck portion 22 of the wiper lip insert 20 may extend through the neck, but not enter the base strip 13.

The reinforcing body inserts 33, 34, 44 are preferably made from a material that is harder than the material used for the wiper lip 11. More specifically, it may be advantageous to use a material having a Shore Hardness A of more than 20 points greater than the hardness of the material of wiper lip 11. In some embodiments, it may be advantageous to use a material with Shore Hardness A in the range of approximately 85±5. In other embodiments, it may be advantageous to use a material with Shore Hardness A in the range of above 90±5. However, persons of skill in the art will recognize that certain implementations of the disclosed concept may use a material for the reinforcing body inserts 33, 34, 44 having a Shore Hardness A of less than 20 points greater than the hardness of the material of the wiper lip 11. Suitable materials include, but are not limited to, high or low density polyethylene (HDPE/LDPE), Nylon, polybutylene terephthalate (PBT), polyethylene terephthalate (PET), polypropylene (PP), polyphenylene sulfide (PPS), or silicone, as well as the same materials used for the wiper lip 11.

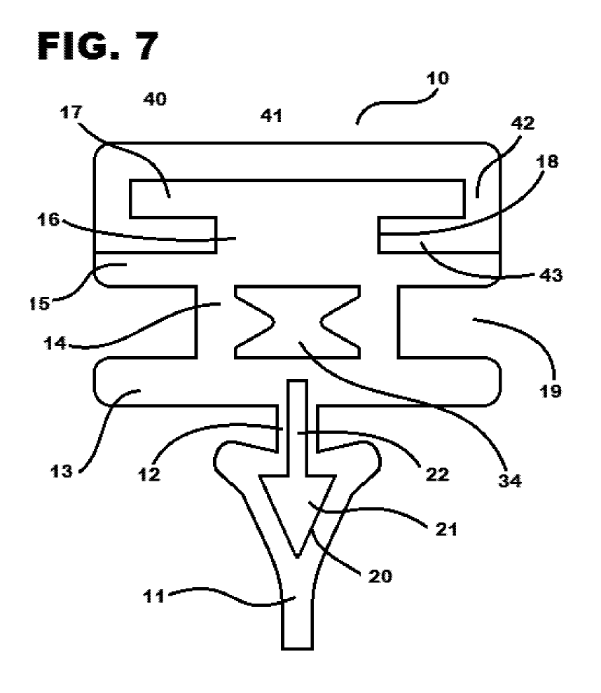

As shown in FIG. 7, a reinforcing cap insert 40 may also be used in lieu of vertebrae 50. In this embodiment, the width of top strip 17 of wiper strip 10 has been decreased, and a cap insert 41 is formed around same. The cap insert may have a cover strip 41, and two cap legs 42 which descend downward along the longitudinal sides of the cap insert 40. The cap insert 40 further has cap claws 18 which are disposed in the grooves 18 formed by the top strip 17, upper body 16 and intermediate strip 15.

The cap insert 40 is preferably made from a material that is harder than the material used for the wiper lip 11. More specifically, it may be advantageous to use a material having a Shore Hardness A of more than 20 points greater than the hardness of the material of wiper lip 11. In some embodiments, it may be advantageous to use a material with Shore Hardness A in the range of approximately 85±5. In other embodiments, it may be advantageous to use a material with Shore Hardness A in the range of above 90±5. However, persons of skill in the art will recognize that certain implementations of the disclosed concept may use a material for the reinforcing body inserts 33, 34, 44 having a Shore Hardness A of less than 20 points greater than the hardness of the material of the wiper lip 11. Suitable materials include, but are not limited to, high or low density polyethylene (HDPE/LDPE), Nylon, polybutylene terephthalate (PBT), polyethylene terephthalate (PET), polypropylene (PP), polyphenylene sulfide (PPS), or silicone, as well as the same materials used for the wiper lip 11.

Despite being made from different materials, the wiper strips 10 of the disclosed concept is preferably manufactured so as to be an integrated, unitary, one-piece structure. Manufacture of the wiper strips of embodiments of disclosed concept is preferably done through a coextrusion or multilayer extrusion process. Such processes combine the multiple materials with varying hardnesses into a unitary piece. After extrusion, the wiper strips may be cured, vulcanized, cut, and coated (with graphite or other coatings known in the art). Other methods of manufacture known in the art, including molding, may be used.

Alternatively, the inserts 20, 31, 32, 33, 34, 40, 44 of the wiper strips 10 of the disclosed concept may be separate pieces that are manufactured separately through any suitable manufacturing process known in the art and later assembled into the wiper strip 10.

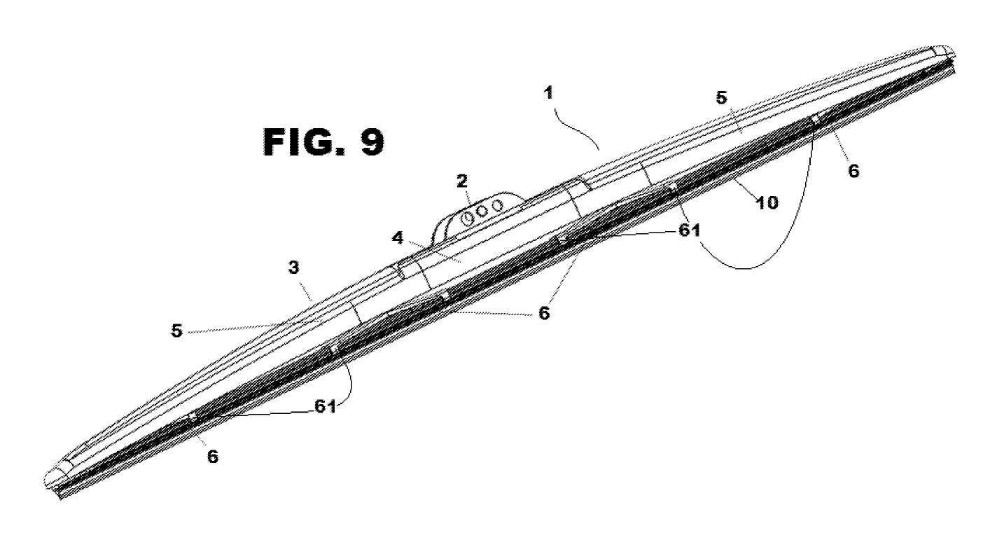

Persons of skill in the art will recognize that the wiper strips of the disclosed concept may be incorporated into any type of wiper blade that is currently known in the art or will be developed in the future, including traditional bracketed wiper blades, beam blades, and hybrid wiper blades which incorporate both beams and brackets. FIG. 9 depicts a wiper blade embodiment of the disclosed concept. The wiper blade 1 may include a mounting base 2 for connecting the wiper blade 1 to a wiper arm. The mounting base 2 may be specially designed to directly accommodate one or more wiper arms, or it may use one or more connectors or adapters (not shown) in order to connect to multiple types of wiper arms. The wiper blade 1 may have a force distribution structure 6, such as a beam, one or more brackets, or a combination of one or more beams and one or more brackets, which distribute the force applied by the wiper arm to the mounting base 2. The force distribution structure 6 may include claws 61, which grip the claw grooves 19 of the wiper strip 10. The wiper blade 1 may also include a cover 3, comprising a mounting base cover 4, and cover sections 5 which extend substantially to the ends of the wiper strip. Other commonplace features known in the art, including without limitation, spoilers and end caps, may also be included in wiper blade embodiments of the disclosed concept.

Certain aspects of the disclosure provide the following non-limiting embodiments:

### Embodiment 1

A wiper strip comprising: a wiper lip made of a first material; a base strip; a neck connecting the wiper lip to the base strip; and a wiper lip insert made of a second material, wherein the second material is harder than the first material, and wherein the wiper lip insert comprises a lip portion that is embedded in the wiper lip.

### Embodiment 2

The wiper strip of embodiment 1, wherein wiper lip insert further comprises a neck portion that extends from the lip portion and is embedded in the neck.

### Embodiment 3

The wiper strip of embodiment 2, wherein the wiper lip insert further comprises a top portion is connected to the neck portion, and that is embedded at least in part, in the base strip, wherein the neck portion has a first width, and the top portion has a second width, the second width is greater than the first width.

### Embodiment 4

The wiper strip of any of embodiments 1-3, wherein the first material has a first hardness and the second material has a second hardness in the range of Shore Hardness A 10-20 points greater than that of the first material

### Embodiment 5

The wiper strip of any of embodiments 1-4, wherein the wiper strip further comprises a main body, and a body insert that is embedded in the main body.

### Embodiment 6

The wiper strip of embodiment 5, wherein the body insert has an hour-glass shape.

### Embodiment 7

The wiper strip of any of embodiments 1-6, wherein the wiper strip further comprises a main body and an intermediate strip, wherein the base strip, main body and intermediate strip form claw grooves.

### Embodiment 8

The wiper strip of embodiment 7, wherein the wiper strip further comprises an upper body and top strip, wherein the top strip, upper body, and intermediate strip form vertebra grooves.

### Embodiment 9

The wiper strip of embodiment 7, wherein the wiper strip further comprises an upper body, a top strip, and a cap insert, wherein the top strip, upper body, and intermediate strip form two grooves, and wherein the cap insert comprises two cap legs, each having a cap claws that engage the two grooves.

### Embodiment 10

The wiper strip of embodiment 7, further comprising a claw groove insert.

### Embodiment 11

The wiper strip of embodiment 8, further comprising a vertebra groove insert.

### Embodiment 12

A wiper blade comprising: a mounting base; a force distribution structure; and a wiper strip, wherein the wiper strip comprises: a wiper lip made of a first material; a base strip; a neck connecting the wiper lip to the base strip; and a wiper lip insert made of a second material, wherein the second material is harder than the first material, and wherein the wiper lip insert comprises a lip portion that is embedded in the wiper lip.

### Embodiment 13

The wiper blade of Embodiment 12, wherein wiper lip insert further comprises a neck portion that extends from the lip portion and is embedded in the neck, and a top portion that is connected to the neck portion and is embedded at least in part, in the base strip, wherein the neck portion has a first width, and the top portion has a second width, the second width is greater than the first width.

### Embodiment 14

The wiper blade of any of Embodiments 12-13, wherein the first material has a first hardness and the second material has a second hardness in the range of Shore Hardness A 10-20 points greater than that of the first material.

### Embodiment 15

The wiper blade of any of Embodiments 12-14, wherein the wiper strip further comprises a main body, and a body insert that is embedded in the main body.

### Embodiment 16

The wiper blade of Embodiment 15, wherein the body insert has an hour-glass shape.

### Embodiment 17

The wiper strip of any of Embodiments 12-16, wherein the wiper strip further comprises a main body and an intermediate strip, wherein the base strip, main body and intermediate strip form claw grooves.

### Embodiment 18

The wiper strip of Embodiment 17, wherein the wiper strip further comprises an upper body and top strip, wherein the top strip, upper body, and intermediate strip form vertebra grooves.

### Embodiment 19

The wiper strip of Embodiment 17, wherein the wiper strip further comprises an upper body, a top strip, and a cap insert, wherein the top strip, upper body, and intermediate strip form two grooves, and wherein the cap insert comprises two legs, each having a claws that engage the two grooves.

### Embodiment 20

A wiper strip comprising: a wiper lip made of a first material; a base strip; an intermediate strip; a top strip; a main body connecting the base strip to the intermediate strip, wherein the base strip, main body and intermediary strip form two claw grooves; an upper body connecting the top strip to the intermediate strip, wherein the top strip, upper body and intermediate strip form two vertebra grooves; a neck connecting the wiper lip to the base strip; a wiper lip insert made of a second material, wherein the second material is harder than the first material by a first amount in the range of Shore Hardness A 10-20 points, and wherein the wiper lip insert comprises a lip portion that is embedded in the wiper lip, and a neck portion that extends from the lip portion and is embedded in the neck; and a body insert made of a third material, wherein the third material is harder than the first material by a second amount in the range of Shore hardness A greater than 20 points, and wherein the body insert is embedded in the main body.

The descriptions set forth above are meant to be illustrative and not limiting, and persons of skill in the art will recognize that various common and known deviations from the above described structures are considered to be within the scope of the disclosed concept described herein.

We claim:

1. A wiper strip comprising:
a wiper lip made of a first material;
a base strip;
a neck connecting the wiper lip to the base strip; and
a wiper lip insert made of a second material, wherein the second material is harder than the first material, and wherein the wiper lip insert comprises a lip portion that is embedded in the wiper lip.

2. The wiper strip of claim 1 wherein wiper lip insert further comprises a neck portion that extends from the lip portion and is embedded in the neck.

3. The wiper strip of claim 2 wherein the wiper lip insert further comprises a top portion is connected to the neck portion, and that is embedded at least in part, in the base strip, wherein the neck portion has a first width, and the top portion has a second width, the second width is greater than the first width.

4. The wiper strip of claim 1 wherein the first material has a first hardness and the second material has a second hardness in the range of Shore Hardness A 10-20 points greater than that of the first material

5. The wiper strip of claim 1 wherein the wiper strip further comprises a main body, and a body insert that is embedded in the main body.

6. The wiper strip of claim 5 wherein the body insert has an hour-glass shape.

7. The wiper strip of claim 1 wherein the wiper strip further comprises a main body and an intermediate strip, wherein the base strip, main body and intermediate strip form claw grooves.

8. The wiper strip of claim 7 wherein the wiper strip further comprises an upper body and top strip, wherein the top strip, upper body, and intermediate strip form vertebra grooves.

9. The wiper strip of claim 7 wherein the wiper strip further comprises an upper body, a top strip, and a cap insert, wherein the top strip, upper body, and intermediate strip form two grooves, and wherein the cap insert comprises two cap legs, each having a cap claws that engage the two grooves.

10. The wiper strip of claim 7 further comprising a claw groove insert.

11. The wiper strip of claim 8 further comprising a vertebra groove insert.

12. A wiper blade comprising:
a mounting base;
a force distribution structure; and
a wiper strip, wherein the wiper strip comprises;
a wiper lip made of a first material;
a base strip;
a neck connecting the wiper lip to the base strip; and
a wiper lip insert made of a second material, wherein the second material is harder than the first material, and wherein the wiper lip insert comprises a lip portion that is embedded in the wiper lip.

13. The wiper blade of claim 12 wherein wiper lip insert further comprises a neck portion that extends from the lip portion and is embedded in the neck, and a top portion that is connected to the neck portion and is embedded at least in part, in the base strip, wherein the neck portion has a first width, and the top portion has a second width, the second width is greater than the first width.

14. The wiper blade of claim 12 wherein the first material has a first hardness and the second material has a second hardness in the range of Shore Hardness A 10-20 points greater than that of the first material.

15. The wiper blade of claim 12 wherein the wiper strip further comprises a main body, and a body insert that is embedded in the main body.

16. The wiper blade of claim 15 wherein the body insert has an hour-glass shape.

17. The wiper strip of claim 12 wherein the wiper strip further comprises a main body and an intermediate strip, wherein the base strip, main body and intermediate strip form claw grooves.

18. The wiper strip of claim 17 wherein the wiper strip further comprises an upper body and top strip, wherein the top strip, upper body, and intermediate strip form vertebra grooves.

19. The wiper strip of claim 17 wherein the wiper strip further comprises an upper body, a top strip, and a cap insert, wherein the top strip, upper body, and intermediate strip form two grooves, and wherein the cap insert comprises two legs, each having a claws that engage the two grooves.

20. A wiper strip comprising:
a wiper lip made of a first material;
a base strip;
an intermediate strip;
a top strip;
a main body connecting the base strip to the intermediate strip, wherein the base strip, main body and intermediary strip form two claw grooves;
an upper body connecting the top strip to the intermediate strip, wherein the top strip, upper body and intermediate strip form two vertebra grooves;
a neck connecting the wiper lip to the base strip;
a wiper lip insert made of a second material, wherein the second material is harder than the first material by a first amount in the range of Shore Hardness A 10-20 points, and wherein the wiper lip insert comprises a lip portion that is embedded in the wiper lip, and a neck portion that extends from the lip portion and is embedded in the neck; and
a body insert made of a third material, wherein the third material is harder than the first material by a second amount in the range of Shore hardness A greater than 20 points, and wherein the body insert is embedded in the main body.
